(19) United States
(12) Patent Application Publication
(10) Pub. No.: US 2015/0066532 A1
(43) Pub. Date: Mar. 5, 2015

(54) MOBILE INFORMATION AND CONTROL DEVICE, AND METHOD FOR USE THEREOF

(71) Applicant: Siemens Aktiengesellschaft, Muenchen (DE)

(72) Inventors: Gerhard Kraemer, Igensdorf (DE); Soeren Kuhrt, Erlangen (DE); Michael Zdarsky, Heroldsbach (DE)

(73) Assignee: Siemens Aktiengesellschaft, Muenchen (DE)

(21) Appl. No.: 14/477,007

(22) Filed: Sep. 4, 2014

(30) Foreign Application Priority Data
Sep. 4, 2013 (DE) 102013217642.2

(51) Int. Cl. G06Q 50/22; G06F 3/041; G06F 19/00; G06Q 10/10

(52) U.S. Cl. CPC G06Q 50/22; G06Q 10/10; G06F 3/041; G06F 19/322; G06F 19/321; G06F 19/327
USPC 705/2

(57) ABSTRACT

A mobile information and control device provides information about a patient and examinations to be conducted on this patient, as well as the ability to control medical apparatuses, for use by medical personnel. The mobile device at least has a data storage device to store and provide information, a coupling device to place the information and control device in communication with additional medical apparatuses, a display for need-specific display of information, and an attachment device to attach the information and control device to a wrist of the personnel. A method to provide information about a patient and examinations to be conducted on this patient, as well as for control of medical apparatuses by medical personnel, makes use of such a mobile information and control device.

### BACKGROUND OF THE INVENTION

1. Field of the Invention

The invention concerns a mobile information and control device to provide information about a patient and examinations to be conducted on this patient, as well as to control medical apparatuses, and the use of such mobile device by medical personnel.

2. Description of the Prior Art

In various everyday situations, it is necessary for medical clinical personnel, both physicians and medical technical assistants (MTAs), for example, to continuously access patient-specific and/or examination apparatus-specific information, or to control an examination apparatus for an examination. It conventionally typical to be able to retrieve or operate on the information and effectuate the control only at fixed locations, for example a computer workstation or an examination apparatus itself.

In order to enable the clinical personnel to have a greater freedom of movement (for example in an office, examination room or waiting room), in recent years mobile information and control devices such as tablet PCs and smartphones have been increasingly used. However, these need to be actively carried or held in one's hand, which makes it difficult to carry them continuously.

Furthermore, wristwatches are known that communicate wirelessly with a cellular phone and can control and execute various types of application software. Such wristwatches are coupled with the cellular phone by means of Bluetooth and receive information from the cellular phone, for example incoming phone calls, messages or e-mails. It is thereby possible to activate a vibration alarm at the wristwatch in order to make a user immediately aware of the incoming information, which is displayed on a display of the wristwatch. Furthermore, arbitrary other application software can also be loaded onto the wristwatch by the user.

### SUMMARY OF THE INVENTION

An object of the invention is to provide a mobile information and control device that is specifically adapted to the clinical everyday environment and the need of the medical personnel, wherein its manageability is simplified.

The invention is based on the insight that a mobile information and control device in a form resembling a wristwatch, which device the medical personnel can always carry simply and comfortably on the wrist in the everyday clinical environment, represents an improvement relative to the previous mobile information and control devices (such as tablet PCs or smartphones) that have been provided for the clinical environment. Information can thus be continuously retrieved by the personnel at the mobile information and control device on the wrist. Furthermore, medical apparatuses such as a CT system or a radiology information system (RIS) can be coupled with the mobile device. A wireless connection—for example by means of Bluetooth or WLAN, is preferable for this. For remote control of the medical apparatuses at the mobile device, it can be equipped with a touch-sensitive touch display.

A processor in the information and control device is connected to all components therein, and coordinates or enables exchange of information and commands among the components.

If no access to information is required or no apparatus is being controlled at a time, the device remains comfortably on the wrist of the personnel and does not additionally need to be laboriously placed in a pocked and be retrieved again as needed. In the following, the mobile information and control device is designed as an “I/S device” for short. For the uses described in the following, the advantages of the mobile I/S device which is to be worn on the wrist in the form of a device similar to a wristwatch are exploited .

An image of the patient as well as his or her name and additional data such as age, height etc., which image, name and data have previously been stored in a data memory of the I/S device, can be shown on the display of said I/S device so that the patient can easily be recognized by the personnel (for example in a waiting room) and be directly addressed by name. A confusion of the patients can thus be precluded.

Patient-specific and/or examination apparatus-specific warning notifications can also be shown at the display, for example a pregnancy, allergies or critical laboratory values. The warning notifications can be displayed in the form of a clear optical or haptic signal; for example, the display blinks red or the I/S device vibrates. Since the I/S device is worn on the wrist, the warning notifications consequently appear on the wrist of the personnel, these are always in the field of view and are hard to overlook.

Furthermore, data stored in the memory of the I/S device with regard to the type of examination to be implemented and examination-specific work steps can be linked with the patient data so that these are shown in conjunction with the patient image on the display. The MTA then knows (without further consultation with the treating physician) for which examination and how the patient the patient is to be prepared. For example, the respective examination steps can be indicated one after another on the display and be respectively retrieved at the display via a manual “OK” confirmation by the personnel, and be confirmed in order to display the next examination step.

For example, typical preparation and/or examination steps can also be displayed. For example, the queries can first be displayed after a declaration of consent by the patient, and the additional examination steps (for example administration of a contrast agent etc.) only appear if this is positively confirmed.

Fundamental and simple control commands of medical apparatuses can likewise be executed by means of the I/S device. For example, for this purpose, a CT system can be coupled with the I/S device by means of a wireless data connection so that the MTA can remotely control the controller of a patient bed, for example.

The mobile I/S device can additionally has a device to recognize the respective environment, i.e. the medical apparatuses that are coupled, controllable, and located in the close environment. For example, this can take place via a radio-frequency identification (RFID). In one embodiment, a transponder for the RFID detection is located in the I/S device and a reader is located in the respective medical apparatus. Only actions that match the respective site or the respective coupled apparatus are thus offered or, respectively, allowed. For example, the control of the patient bed is possible only in the direct environment of the patient bed, or an activation of the x-ray scanner can take place only if the wearer of the I/S device is located outside of the examination room. A haptic and/or optical warning signal can also be passed to the display in this regard as long as the wearer is still located in the examination room. The environment detection of the I/S device can additionally be used to monitor a position of the wearer (for example at a central point) in order to be able to make quicker contact with the wearer, for example, or in order to know which personnel can be on site most quickly in the event of emergency.

Furthermore, the mobile I/S device can induce a personnel recognition so that respective different user-specific control modules can be enabled at the respective examination apparatus depending on the competency of the wearer of the I/S device (thus for example the MTA or physician).

Compared to the use of other wearable I/S devices, the following advantages result from the inventive device.

The necessity to additionally carry a mobile I/S device along in a pocket, take it out from the pocket and place it back again is avoided because the I/S device is normally not stored and then forgotten in the course of the workflow. The danger of damage to the I/S device due to a fall is largely avoided. A free hand is not required to read information. Warning messages cannot be overlooked due to the position of the wrist, particularly given haptic warning notifications. Due to the continuous connection with the wearer, his or her position in space can be identified, and this information can be used for additional safety measures.

The invention encompasses an improved mobile information and control device to provide information about a patient and examinations to be conducted on this patient, as well as to control medical apparatuses, for use by medical personnel, which mobile information and control device has at least: a data storage device to store and provide information; a coupling device to connect the information and control device with additional medical apparatuses; a display to show information specifically as needed; and an attachment device to attach the information and control device to a wrist of the personnel. Such mobile I/S devices are preferably designed to be worn by the wearer on the wrist, so the device is always in the wearer's field of view and is not forgotten in the everyday clinical environment. Information can be continuously and flexibly retrieved with the mobile I/S device according to the invention. Furthermore, a connection with different medical apparatuses can be established via the coupling device.

The wearer of the mobile I/S device is preferably clinical personnel such as physicians, MTA, nurses etc.

The mobile I/S device has a data storage device in which information and data are stored and provided for flexible retrieval. At least the following information are advantageously stored in the data storage device: image of the patient; patient data; anamnesis data; type of examination to be conducted; examination steps of the examination to be conducted; and apparatus data.

The mobile I/S device is connected with additional medical apparatuses (such as CT systems and radiology information systems) by means of the coupling device. This connection is preferably a wireless data connection, for example a Bluetooth and/or WLAN connection.

Furthermore, a control device is provided with which a medical apparatuses can be remotely controlled from the mobile I/S device. Via the wireless data connection, the wearer of the I/S device is no longer bound to a fixed workstation, but rather can move freely in a limited radius to control the apparatus.

In an embodiment, the control device has a touch-sensitive display (also called a touch display). The display is preferably designed to display information as a touch display to control the I/S device. The mobile I/S device is thereby comfortable to operate simply with one hand or, respectively, even with one finger of the wearer. In another embodiment, the control device comprises a speech controller. The speech controller enables a reliable control of the mobile I/S device even in difficult situations. In yet another embodiment, the control device has a person recognition application. The speech control can be personalized by the person recognition application so that unauthorized persons cannot accidentally or intentionally input speech commands. Respective user-specific control modules of the coupled medical apparatuses can be unlocked via the person recognition application so that the wearer of the I/S device can remotely control the coupled examination apparatuses with the corresponding control commands depending on his competency and authorization as a physician or MTA. A fingerprint sensor, a retina scanner and/or a voice recognition can be provided as the person recognition application.

In a further preferred embodiment of the mobile I/S device provides a warning device is provided in the I/S device that communicates warning signals to the person wearing the I/S device. For example, a warning indication of pregnancy or specific allergies of the patient can be made. The warning signal is preferably an acoustic, optical, haptic and/or vibration alarm. In one embodiment, a beep is used as an acoustic warning signal. Another embodiment provides a blinking of the display as an optical warning signal, or vibration of the I/S device. The different warning signals can thereby be arbitrarily combined with one another, and their strength and intensity can be adapted to the respective situation.

In another embodiment provides an environment recognition device is provided that detects and identifies medical apparatuses located in the close environment of the I/S device for exclusive coupling and control. This ensures that the mobile I/S device couples exclusively with the apparatuses located in the immediate environment, and furthermore that only the matching control commands corresponding to these apparatuses are available in order to simplify the operation of the device.

The attachment device of the mobile I/S device is preferably fashioned as a one-part or two-part attachment similar to a wristwatch strap, such that the mobile I/S device is comfortable to wear on the wrist, and the circumference or the strength of the attachment can be varied.

Furthermore, the invention concerns a method to use of a mobile information and control device according to the invention as described above to provide information about a patient and examinations to be conducted on this patient, as well as for the control of medical apparatuses by medical personnel. The medical personnel preferably uses the mobile I/S device in an everyday clinical environment.

### BRIEF DESCRIPTION OF THE DRAWINGS

FIG. 1 illustrates a mobile information and control device in accordance with the invention on a wrist of a wearer.

FIG. 2 is a further illustration of operation of the mobile information and control device according to FIG. 1.

FIG. 3 is a further illustration of operation of the mobile information and control device according to FIG. 1.

### DESCRIPTION OF THE PREFERRED EMBODIMENTS

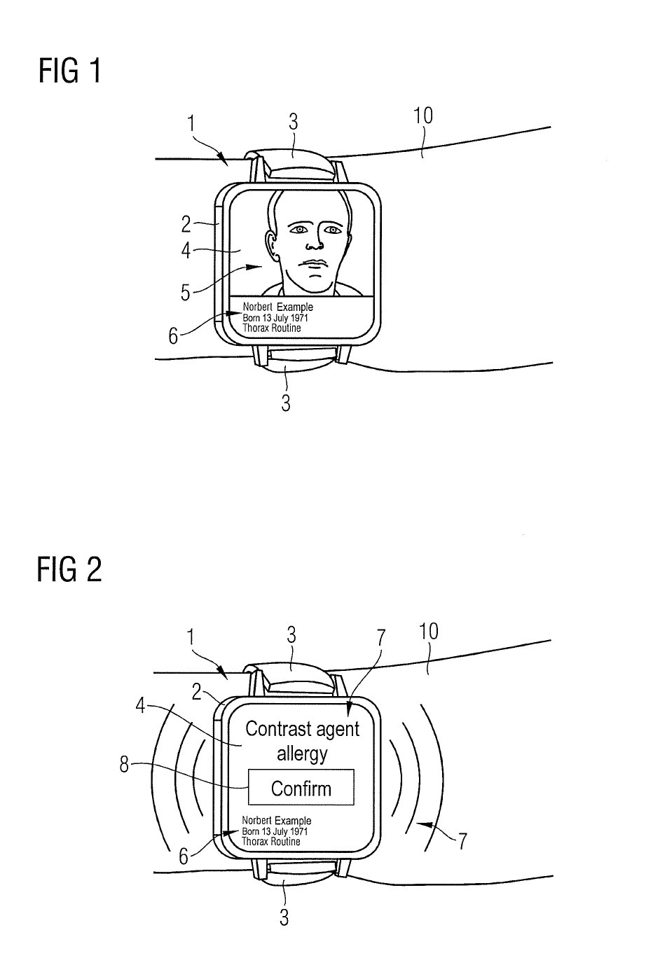

FIGS. 1 through 3 respectively show a mobile information and control device 1 on a wrist 10 of a wearer. The wearer is, for example, an MTA in a radiology station of a hospital. The mobile I/S device 1 serves to provide information about a patient and examinations to be conducted on this patient, as well as to control medical apparatuses, and is provided for use by medical personnel. In the embodiment shown here, the I/S device 1 has a data storage device to store and provide information and a coupling device to place the information and control device 1 in communication with one or more medical apparatuses, for example a CT system. In the embodiment shown here, the I/S device 1 has a flat, quadrilateral housing 2 in which the data storage device and the coupling device are arranged. The housing 2 is attached to the wrist 10 of the wearer by means of an attachment device 3. The mobile I/S device thus resembles a wristwatch. A display 4 for need-specific display of information is executed on a top side of the housing 2. In this embodiment, the display 4 is a touch-sensitive touch display 4.

The presentations of the mobile I/S device 1 that are shown in FIGS. 1 through 3 respectively differ with regard to the illustrated use.

In FIG. 1, the display 4 shows an image 5 of a patient. Basic data 6 of the patient (such as his name and age and the examination to be conducted) are additionally shown on the display 4. With the use of the image 5, the MTA or nurse can easily recognize the patient in a full waiting room and directly address him by name, and furthermore knows which examination is to be conducted without consulting with the treating physician, such that she can prepare the patient accordingly.

In order to be notified of possible allergies or other distinctive features (for example a pregnancy) of the patient in the examination preparations, such data can likewise be stored in the control device and appear on the display 4 as warning notifications. For example, such warning notifications include an optical and acoustic warning signal 7 in the form of a red blinking display 4 combined with a beep. This use case is shown in FIG. 2. In order to turn off the warning signals 7, or in order for the wearer to confirm that the warning notification has been realized and handled accordingly, a confirmation is made possible directly at the I/S device 1. For this, the touch display 4 has a confirmation field 8 which is controlled by tapping with a finger.

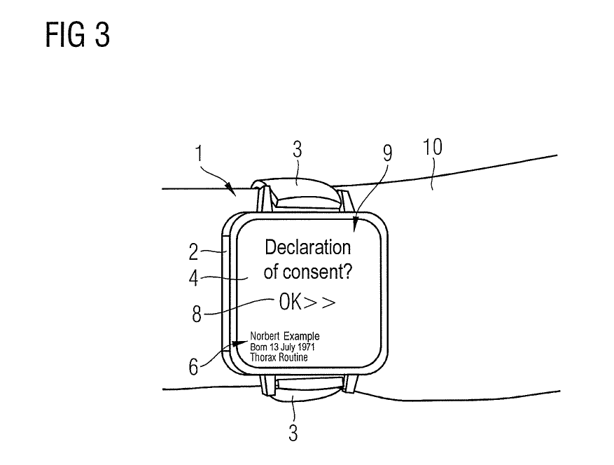

In addition, individual work steps or examination steps 9 can be queried on the display 4 of the mobile I/S device 1. The examination step 9 “declaration of consent” is queried at the display 4 shown in FIG. 3. Only after a positive confirmation on the confirmation field 8 (“OK”) are additional working steps displayed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A mobile information and control device, comprising:
a device housing having a size and shape allowing said device housing to rest on a human wrist;
a data storage device in said device housing that contains information configured to control a medical apparatus;
a processor in said housing configured to retrieve said information from said data storage device;
a coupling device connected to said processor that places said processor in communication with a medical apparatus and that conveys said information retrieved from said data storage device to said medical apparatus to control said medical apparatus;
an attachment device that attaches said device housing to said wrist; and
a display at a surface of said housing that is visible to a wearer of the device housing when the device housing is attached to the wrist of the wearer, said processor being configured to display need-specific information retrieved from said data storage device at said display.

2. An information and control device as claimed in claim 1 wherein said data storage device contains information selected from the group consisting of an image of a patient, patient data associated with a patient, and anamnesis data, information describing a type of examination to be implemented by said medical apparatus, and examination steps of an examination to be implemented by said medical apparatus, and apparatus data describing said medical apparatus.

3. An information and control device as claimed in claim 1 wherein said coupling device produces a wireless data connection between said coupling device and said medical apparatus.

4. An information and control device as claimed in claim 3 wherein said coupling device produces said wireless data connection selected from the group consisting of a Bluetooth connection and a WLAN connection.

5. An information and control device as claimed in claim 1 wherein said coupling device is configured to communicate with a computed tomography apparatus, as said medical apparatus.

6. An information and control device as claimed in claim 1 wherein said coupling device is also configured to communicate with a radiology information system.

7. An information and control device as claimed in claim 1 wherein said processor is configured to operate said display and said coupling device to remotely control operation of said medical apparatus.

8. An information and control device as claimed in claim 7 wherein said display is a touch-sensitive display.

9. An information and control device as claimed in claim 8 wherein said processor comprises a person recognition application configured to unlock user-specific control modules of said medical apparatus upon recognition of a specific person.

10. An information and control device as claimed in claim 9 wherein said person recognition application is selected from the group consisting of a fingerprint sensor, a retina scanner and a voice recognition system.

11. An information and control device as claimed in claim 1 comprising a speech controller in said device housing, and wherein said processor is configured to detect speech commands via said speech controller and to provide control information, via said coupling device, to said medical apparatus dependent on said speech commands.

12. An information and control device as claimed in claim 11 wherein said processor comprises a person recognition application configured to unlock user-specific control modules of said medical apparatus upon recognition of a specific person.

13. An information and control device as claimed in claim 12 wherein said person recognition application is selected from the group consisting of a fingerprint sensor, a retina scanner and a voice recognition system.

14. An information and control device as claimed in claim 1 comprising a warning device contained in said device housing that communicates a warning signal to said wearer under conditions detected by said processor.

15. An information and control device as claimed in claim 14 wherein said warning device is configured to emit a warning signal selected from the group consisting of an acoustic signal, an optical signal, a haptic signal, and a vibration.

16. An information and control device as claimed in claim 1 comprising an environment detection device contained in said device housing that detects at least said medical apparatus, and wherein said processor is configured to communicate exclusively, via said coupling device, with the medical apparatus detected by said environment detection device, for control of said medical apparatus detected by said environment detection device.

17. A method for controlling a medical apparatus comprising:
attaching a device housing, having a size and shape allowing said device housing to rest on a human wrist, to a human wrist;
in a data storage device in said device housing storing information configured to control a medical apparatus;
with a processor in said housing, retrieving said information from said data storage device;
via a coupling device connected to said processor, placing said processor in communication with a medical apparatus and conveying said information retrieved from said data storage device to said medical apparatus to control said medical apparatus; and
at a display at a surface of said housing that is visible to a wearer of the device housing when the device housing is attached to the wrist of the wearer, displaying need-specific information retrieved from said data storage device at said display.
